(19) United States
(12) Patent Application Publication
(10) Pub. No.: US 2024/0018613 A1
(43) Pub. Date: Jan. 18, 2024

(54) METHOD FOR MANUFACTURING RECYCLED LEATHER SHEET

(71) Applicant: Gi Cheon EOM, Suwon-si, Gyeonggi-do (KR)

(72) Inventor: Gi Cheon EOM, Suwon-si, Gyeonggi-do (KR)

(21) Appl. No.: 18/247,777

(22) PCT Filed: Apr. 9, 2021
(86) PCT No.: PCT/KR2021/004463

§ 371 Date: Apr. 4, 2023

(30) Foreign Application Priority Data
Oct. 5, 2020 (KR) 10-2020-0128320

(51) Int. Cl. C14B 7/04; C14B 7/06

(52) U.S. Cl. CPC C14B 7/04; C14B 7/06

(57) ABSTRACT

A method for producing a recycled leather fabric according to an embodiment of the present invention may comprise steps of: processing cowhide pieces or waste to produce cotton-like leather fiber; preparing a mixture by mixing the cotton-like leather fiber with cotton-like fiber; producing a leather thread by spinning the mixture; weaving the leather thread to produce a fabric; crushing and beating cowhide to produce cowhide short fibers; laminating the cowhide short fibers onto the fabric; and entangling the laminated cowhide short fibers with the leather thread by pressing the cowhide short fibers into the fabric.

### TECHNICAL FIELD

The present invention relates to a method for producing a recycled leather sheet.

### BACKGROUND ART

In general, in the process of processing leather, dirt and hair are first removed from raw hides by soaking and liming. The splitting process is also called splitting, and is a process of splitting the limed pelt into desired thickness. In the tanning process, animal proteins are converted into mineral proteins using chromium. The cowhide subjected to these processes is dewatered to a water content of 50 to 60%, and then the thickness thereof is adjusted according to the grade. In addition, the fabric with the adjusted thickness is subjected to dyeing, drying, milling, and embossing, thereby finally making a leather fabric.

Waste is generated during the leather production process, and scrap such as powder or pieces remain after the use of the waste. A method of producing recycled leather by recycling such waste or scrap is widely known.

Korean Patent No. No. 10-0815634 discloses a method for producing a recycled leather sheet, the method comprising steps of: adding and treating shaved pieces with natural rubber or latex; mixing the resultant with waterproofing and flame retardants; solidifying the mixture; and compressing the solidified mixture to form a sheet.

However, the prior art document described above is based on a wet method of bonding leather waste pieces together by simple mixing with the adhesive material latex, and has problems, including very weak tensile and tear strengths and the occurrence of secondary pollution or environmental problems due to the excessive use of chemicals.

That is, the leather sheet produced according to the conventional art has a problem that does not satisfy the tensile strength, tear strength, flexibility, thickness, etc. required in various industrial fields. Due to this problem, it is unreasonable to apply the leather sheet to products such as car seats, bags, and furniture, which are subject to repetitive external forces and contact.

### DISCLOSURE

### Technical Problem

The present invention has been made in view of the above-described background art, and is intended to provide a method of producing a recycled leather sheet, which is environmentally friendly and has improved physical properties such as strength, by recycling leather pieces or waste.

### Technical Solution

A method for producing a recycled leather sheet according to one embodiment of the present invention may comprise steps of: processing cowhide pieces or waste to produce cotton-like leather fiber; preparing a mixture by mixing the cotton-like leather fiber with cotton-like fiber; producing a leather thread by spinning the mixture; weaving the leather thread to produce a fabric; crushing and beating cowhide to produce cowhide short fibers; laminating the cowhide short fibers onto the fabric; and entangling the laminated cowhide short fibers with the leather thread by pressing the cowhide short fibers into the fabric.

The step of preparing the mixture may further comprise a step of determining the mixing amount of the cotton-like leather fiber depending on the required strength of the leather thread.

The mixing ratio between the cotton-like leather fiber and the cotton-like fiber may be 60 to 95 wt %: 5 to 40 wt %.

The step of entangling may comprise spraying high-pressure water so that the cowhide short fibers are pressed and placed between the adjacent threads of the fabric.

The cotton-like fiber may comprise at least one material selected from among cotton, nylon, acrylic resin, polyester, polypropylene, rayon, and linen.

### Advantageous Effects

The method for producing a recycled leather sheet according to one embodiment of the present invention may prevent environmental pollution by recycling leather pieces or waste.

In addition, it is possible to provide a recycled leather sheet having improved physical properties such as tensile strength, tear strength, and flexibility by entangling cotton-like leather fiber with a fabric made of leather fiber and synthetic fiber.

### BRIEF DESCRIPTION OF DRAWINGS

FIG. 1 is a flow chart of a method for producing a recycled leather sheet according to one embodiment of the present invention.

FIG. 2 is a photograph of a recycled leather sheet produced according to one embodiment of the present invention.

### MODE FOR INVENTION

Hereinafter, embodiments of the present invention will be described in detail with reference to the accompanying drawings so that those skilled in the art can easily carry out the present invention. The present invention may be embodied in a variety of different forms and is not limited to the embodiments disclosed herein.

In the drawings, parts irrelevant to the description are omitted in order to clearly describe the present invention, and like reference numerals denote like parts throughout the specification.

In addition, the size and thickness of each component shown in the drawings are represented for convenience of explanation, and thus the present invention is not necessarily limited to the illustrated size and thickness of each component.

Throughout the specification, it is to be understood that when any part is referred to as “comprising” any component, it does not exclude other components, but may further include other components, unless otherwise specified.

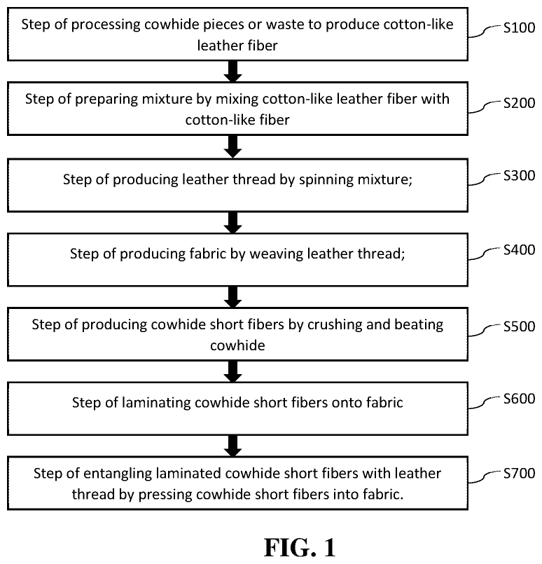

FIG. 1 is a flow chart of a method for producing a recycled leather sheet according to one embodiment of the present invention.

Referring to FIG. 1, a method for producing a recycled leather sheet according to one embodiment of the present invention may comprise steps of: (S100) processing cowhide pieces or waste to produce cotton-like leather fiber; (S200) preparing a mixture by mixing the cotton-like leather fiber with cotton-like fiber; (S300) producing a leather thread by spinning the mixture; (S400) weaving the leather thread to produce a fabric; (S500) crushing and beating cowhide to produce cowhide short fibers; (S600) laminating the cowhide short fibers onto the fabric; and (S700) entangling the laminated cowhide short fibers with the leather thread by pressing the cowhide short fibers into the fabric.

First, cowhide pieces or waste may be processed to produce cotton-like leather fiber (S100). For example, leather pieces or waste may be crushed and beaten to expose fine leather fibers, and the leather fibers obtained in this way may be scutched using a scutcher to make cotton-like leather fiber. In this case, the length of the leather fiber forming the cotton-like leather fiber is 0.1 mm to 2 cm, and the thickness thereof may be 0.01 mm to 0.1 mm.

Then, a mixture may be prepared by mixing the cotton-like leather fiber with cotton-like fiber (S200). The cotton-like fiber is one formed by entangling synthetic fibers. For example, the cotton-like fiber may comprise at least one of materials such as cotton, nylon, acrylic resin, polyester, polypropylene, rayon, and linen. A cotton-like mixture may be prepared by mixing the cotton-like fiber with the cotton-like leather fiber.

Meanwhile, step (S200) of preparing the mixture may further comprise a step of determining the mixing amount of the cotton-like leather fiber depending on the required strength of the leather thread. In this case, the mixing ratio between the cotton-like leather fiber and the cotton-like fiber may be 60 to 95 wt %: 5 to 40 wt %.

For example, the mixing ratio between the cotton-like leather fiber and the cotton-like fiber is 70 to 90 wt %: 10 to 30 wt % when nylon is used as the cotton-like fiber, 70 to 90 wt %: 10 to 30 wt % when acrylic resin is used as the cotton-like fiber, 70 to 90 wt %: 10 to 30 wt % when polyester is used as the cotton-like fiber, 70 to 90 wt %: 10 to 30 wt % when polypropylene is used as the cotton-like fiber, 70 to 90 wt %: 10 to 30 wt % when cotton is used as the cotton-like fiber, 70 to 90 wt %: 10 to 30 wt % when rayon is used as the cotton-like fiber, and 70 to 90 wt %: 10 to 30 wt % when linen is used as the cotton-like fiber.

Here, as the weight proportion of the cotton-like fiber increases, the strength of the leather thread may increase, and as the weight proportion of the cotton-like leather fiber increases, the strength of the leather thread relatively slightly increases, but the leather texture may be well expressed. Therefore, the mixing ratio between the cotton-like leather fiber and the cotton-like fiber may be determined depending on the required strength of the leather yarn, and the cotton-like leather fiber and the cotton-like fiber may be added and mixed together at predetermined wt % depending on the predetermined mixing ratio, thereby preparing a cotton-like mixture.

Thereafter, a leather thread may be produced by spinning the mixture (S300).

To this end, step (S300) of producing the leather thread by spinning may comprise browing, carding, combing, drawing, roving and spinning processes.

Browing is a process of loosening cotton well and removing dust, blemishes and impurities.

Carding is a process of separating agglomerated fibers from the cotton subjected to the browing process. After the carding process, a combing process of further removing impurities and separating agglomerated fibers may be performed.

Drawing is a process of combining several strands of slivers resulting from the carding process or the combing process and straightening and uniformly stretching the fibers.

Roving is a process of stretching the sliver resulting from the drawing process to a smaller thickness. Spinning is a process of making a thread while twisting the sliver to a thickness desired by a user and winding the thread around a bobbin. The cotton-like mixture may be made into a leather thread composed of leather fiber and synthetic fiber through these spinning processes.

Thereafter, a fabric may be produced by weaving the leather thread (S400). For example, a fabric may be produced by weaving weft and warp yarns disposed to cross the produced leather yarn at right angles.

Next, cowhide short fibers may be produced by crushing and beating cowhide (S500). Cowhide short fibers may be produced by crushing and beating cowhide pieces or waste to expose microfibers. For example, the length of the cowhide short fiber may be 0.1 mm to cm, and the thickness thereof may be 0.01 mm to 0.1 mm.

Thereafter, the cowhide short fibers may be laminated onto the fabric (S600). These cowhide short fibers may be arranged and laminated on the fabric, or formed in a web shape and then laminated. The density of one layer composed of the cowhide short fibers may be 40 g/m². These cowhide short fibers may be laminated on the fabric to form a plurality of layers. In this case, the thickness of the cowhide short fibers laminated on the fabric may be 0.1 to 1.0 mm.

Thereafter, the laminated cowhide short fibers may be pressed into the fabric so as to be entangled with the leather thread (S700). For example, for entanglement, a method of spraying high-pressure water by a water jet may be used. In this case, a high-pressure water stream of 50 kg/cm²G or more may be sprayed on the cowhide short fibers laminated on the fabric by a water jet, and the cowhide short fibers may be pressed between the leather threads in the fabric by the water pressure and may be firmly bonded to the leather threads.

As another example, a punching method using needles may be used for entanglement. In this case, by placing a plurality of needles on the fabric and then moving the needles up and down, the cowhide short fibers laminated on the fabric may be punched, inserted between the leather threads in the fabric and firmly bonded to the leather threads.

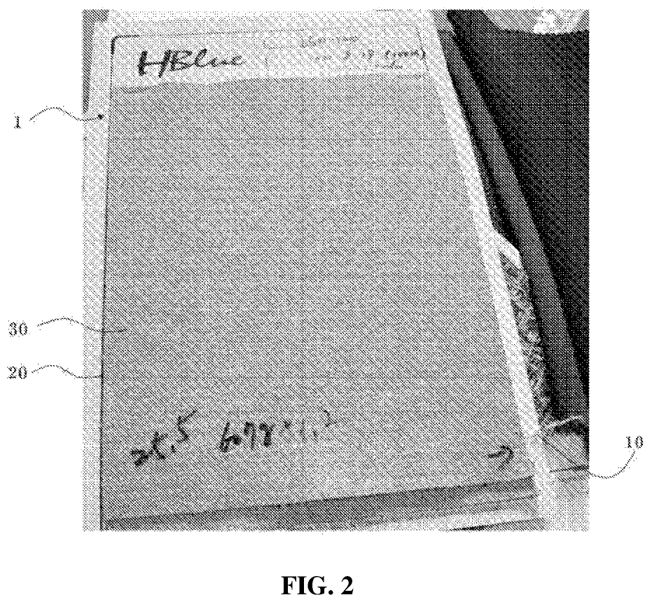

FIG. 2 is a photograph of a recycled leather sheet produced according to one embodiment of the present invention.

Referring to FIG. 2, a recycled leather seat 1 produced according to one embodiment of the present invention is one produced by entangling cowhide short fibers 30 with a fabric 20 produced by weaving a thread 10 composed of leather fiber and synthetic fiber. This recycled leather sheet 1 may have high tensile strength and tear strength and may also be light in weight. In addition, the leather fibers constituting the cowhide short fibers 30 may densely protrude from the surface of the fabric, giving a soft and luxurious feel to the surface.

In addition, since the recycled leather sheet 1 does not require a separate reinforcing sheet and urethane adhesive, labor costs may be reduced. In addition, the recycled leather sheet 1 has a uniform thickness, strength and elasticity throughout the sheet, and the use of chemicals may be minimized, resulting in an environmentally friendly effect.

Although one embodiment of the present invention has been described above, the spirit of the present invention is not limited to the embodiments disclosed herein, and those skilled in the art who understand the spirit of the present invention may easily suggest other embodiments by adding, changing or deleting elements within the same spirit, but the other embodiments also fall within the scope of the present invention.

### DESCRIPTION OF REFERENCE NUMERALS

1: recycled leather sheet
10: thread; 20: fabric
30: cowhide short fibers

1. A method for producing a recycled leather sheet, the method comprising steps of:
processing cowhide pieces or waste to produce cotton-like leather fiber;
preparing a mixture by mixing the cotton-like leather fiber with cotton-like fiber;
producing a leather thread by spinning the mixture;
producing a fabric by weaving the leather thread;
producing cowhide short fibers by crushing and beating cowhide;
laminating the cowhide short fibers onto the fabric; and
entangling the laminated cowhide short fibers with the leather thread by pressing the cowhide short fibers into the fabric.

2. The method of claim 1, wherein the step of preparing the mixture further comprises a step of determining a mixing amount of the cotton-like leather fiber depending on a required strength of the leather thread.

3. The method of claim 1, wherein a mixing ratio between the cotton-like leather fiber and the cotton-like fiber is 60 to 95 wt %: 5 to 40 wt %.

4. The method of claim 1, wherein the step of entangling comprises spraying high-pressure water so that the cowhide short fibers are pressed and placed between adjacent threads of the fabric.

5. The method of claim 1, wherein the cotton-like fiber comprises at least one material selected from among cotton, nylon, acrylic resin, polyester, polypropylene, rayon, and linen.
